(19) United States
(12) Patent Application Publication
(10) Pub. No.: US 2008/0062823 A1
(43) Pub. Date: Mar. 13, 2008

(54) Device for Storing, Managing and/or Retrieving Data Stored on Data Carriers, in Particular on Cd's

(76) Inventor: Andreas Lisson, Duisburg (DE)

Correspondence Address: Horst M. Kasper, 13 Forest Drive, Warren, NJ, 07059, US

(21) Appl. No.: 11/628,085

(22) PCT Filed: May 27, 2005
(86) PCT No.: PCT/EP05/05733

§ 371 Date: Nov. 29, 2006

(30) Foreign Application Priority Data
May 31, 2004 (PL) P-368253

(51) Int. Cl. G11B 17/22

(52) U.S. Cl. 369/30.34; 369/30.28

(57) ABSTRACT

Device (2) for storing, managing and/or retrieving data stored on data carriers, in particular on CD's, comprising a set of plates (1) with recesses (3) for data carriers, situated one above another. The adjoining plates (1) are connected by shaped key joints (7,8), preferably in the form of a groove and a spline, which after assembly in top view resemble a circle or a circular sector. The side external parts (24) of the plates (1) at least partly constitute the casing of the device (2). The plates (1) have open passages (5) which create at least one vertical chamber (9) placed inside a rotatable ring set by key joints (7,8), and a rotating unit (11) of the plates (1) is situated inside the chamber (9). The rotating unit (11) is preferably a motor-driven, vertical rod (12) with a non fully circular section, on which a sliding body (14) equipped with a plate driver (15) for rotating selected plate (X) is mounted. The sliding body (14) of the driver (15) is joined with a movable string (19), preferably in the form of an endless belt running along the plates (1), which string prevents the plates (1) from undesirable rotation and has a recess or a break (21) aligned with the plate driver (15), the said recess or a break (21) being compatible with a blocking protrusion (20) located on each plate (1).

The subject of the invention is a device for storing, managing and/or retrieving data stored on data carriers, in particular on CD's, used especially as a mulitidisc multimedia player.

There is a player, described, for instance, in German patent specification DE 522706, which has a magazine placed in a casing containing several data carriers. The magazine consists of several plates containing the discs. The plates are positioned horizontally, one above another, all being rotatably mounted on one common rod. The said rod is slidably mounted on another rod which is stationary in relation to the casing. Each plate has a circular recess with a narrow opening, through which another stationary rod goes in order to prevent the rotation of the plates with data carriers. There is a narrowing on the said rod, which allows for the rotation of a plate positioned against it. The narrowing aligns with a data reader which reads and processes data stored on the particular disc. The motion of the magazine against the rod is realised by a set of strings. After the selected plate has been delivered to the level of the data reader, it is rotated by a drive unit to its working position.

Another device for sequentially feeding a plurality of disk-shaped recording media containing a magazine is known from US patent specification U.S. Pat. No. 4,730,292. The magazine consists of several flat plates with seats for disk-shaped recording media. All the plates of the magazine are rotatable about a common axis. Each plate has an open passage located inside the seat. The selected plate with the recording medium is rotated to a pre-set position and then a lifting apparatus is applied. The lifting apparatus reaches the level of the selected recording medium, and then goes through the open passage and lifts the recording medium to the position at which the data recording or reproducing operation can be performed. After the operation is finished the recording medium in question is lowered to its seat in the plate which, in turn, is moved back to its initial position.

According to the invention the device for storing, managing and/or retrieving data stored on data carriers, in particular on CD's, is characterised by the fact that adjoining plates are connected by shaped key joints, preferably in the form of a groove and a spline, which after assembly in top view resemble a circle or a circular sector, and the side external parts of the plates, at least partly, constitute the casing of the device. The plates have open passages which create at least one vertical chamber, preferably placed inside a rotatable ring set by the key joint, and a rotating unit is situated inside the chamber.

In preferred embodiment of the invention the rotating unit is a motor-driven vertical rod with a non-fully circular section. A sliding body equipped with a rotatable plate driver is mounted on the said rod. The sliding body of the driver is joined with a movable string, preferably an endless belt running along the plates. The purpose of the belt is to prevent the plates from rotating. The belt has a recess or a break aligned with the plate driver, the said recess being compatible with a blocking protrusion located on each plate.

It is also preferred when the open passages in the plates create an additional vertical chamber where the data reader and/or recording device and/or lifting unit for transporting data carriers and/or data reader and/or recording device are located.

Preferably the sliding body of the plate driver is additionally mounted on at least one stationary stabilising rod.

According to the variation of the invention the device for storing, managing and/or retrieving data stored on data carriers, in particular on CD's, is characterised by the fact that adjoining plates are placed on a common hollow core, with a top view of a circular sector preferably in the angle range between 180° and 210°, and the side external parts of the plates, at least partly, constitute the casing of the device. Inside the core the rotating unit is situated.

In preferred embodiment of the invention the rotating unit is a motor-driven vertical rod with a non-fully circular section. A sliding body equipped with a rotatable plate driver is mounted on the said rod. The sliding body of the driver is joined with a movable string, preferably an endless belt running along the plates. The purpose of the belt is to prevent the plates from rotating. The belt has a recess or a break aligned with the plate driver, the said recess being compatible with a blocking protrusion located on each plate.

It is also preferred when the open passages in the plates create an additional vertical chamber where the data reader and/or recording device and/or lifting unit for transporting data carriers and/or data reader and/or recording device are located.

Preferably the sliding body of the plate driver is additionally mounted on at least one stationary stabilising rod.

Device for storing, managing and/or retrieving data according to the invention has a simple and compact construction. The side external parts of the plates, at least partly, constitute the casing of the device and the rotating unit is located inside the plates. Such construction ensures compactness of the device as well as effectively protects the recording media against dust. What is more, the device is versatile. Firstly, it can serve exclusively for storing data carriers such as CD's or DVD's, allowing for quick access to the selected item, which is convenient while searching for a particular item among many. Secondly, the device can be equipped with a data reader and/or recording device, and then it can serve as a multimedia player.

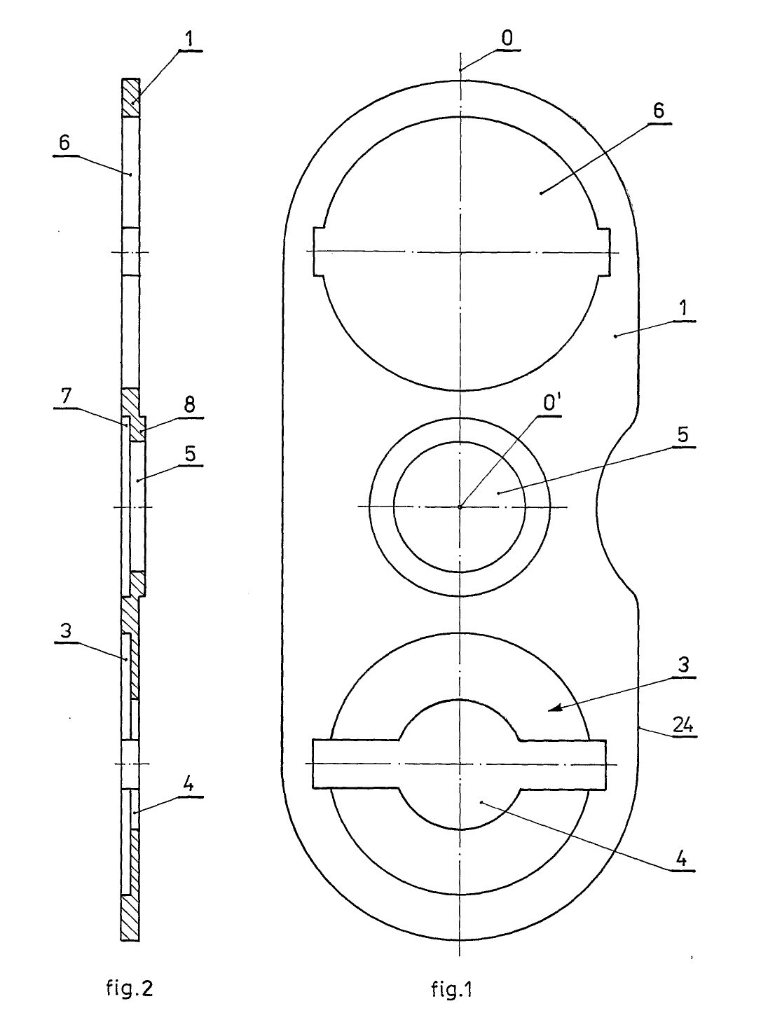

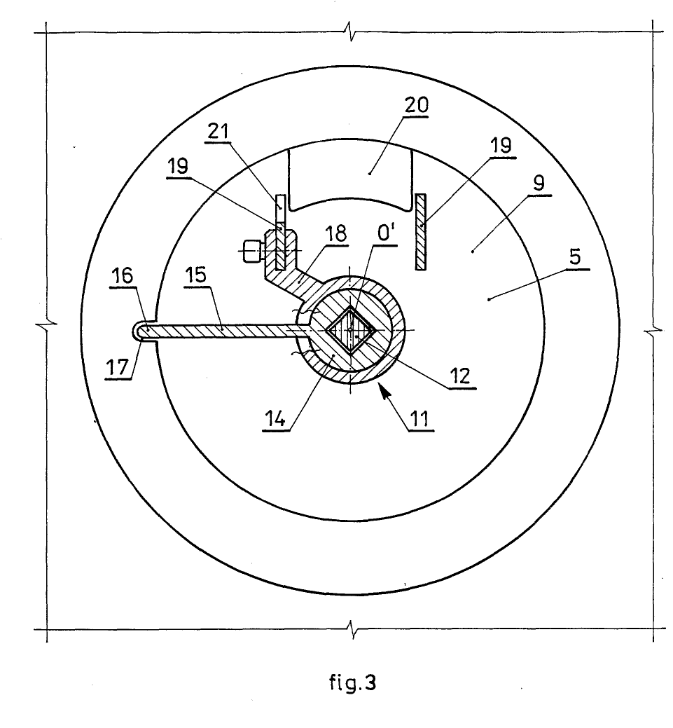

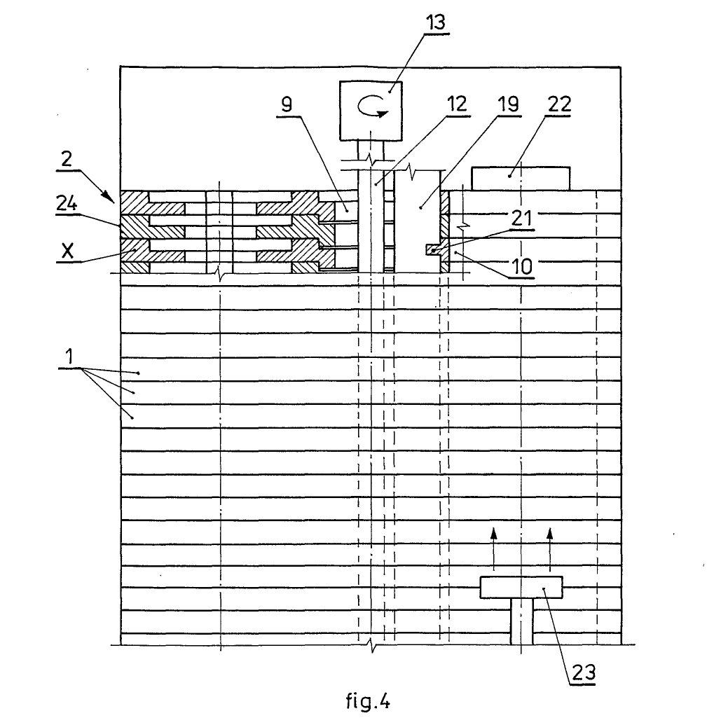

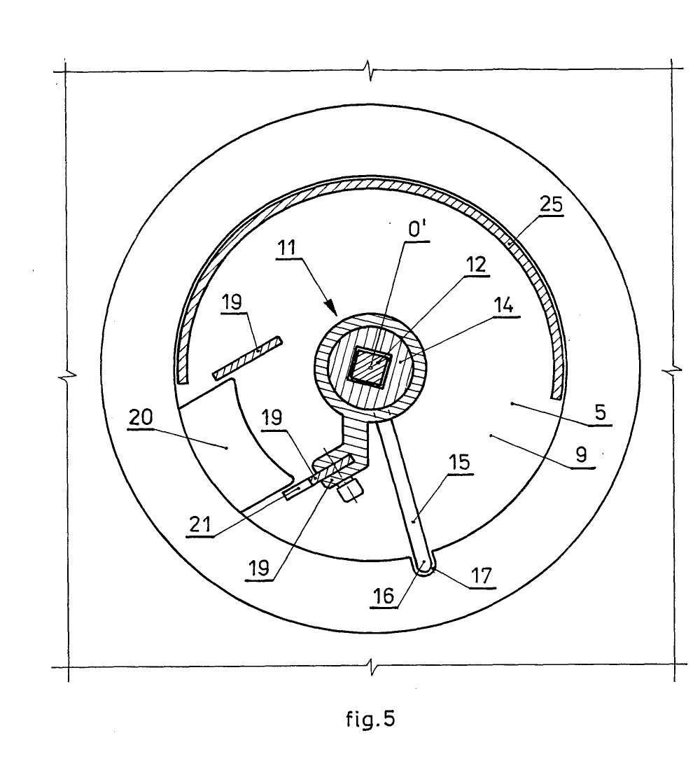

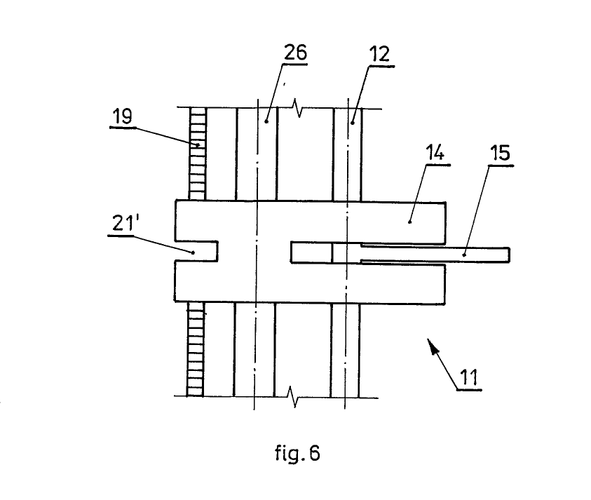

The invention has been described in the following embodiments with reference to FIGS. 1-5, where FIG. 1 is a schematic top view of a single plate, FIG. 2 is a side view of the plate shown in FIG. 1, FIG. 3 is a schematic top view of a portion of a plate with the rotating unit, FIG. 4 is a schematic partial sectional longitudinal view of the device, FIG. 5 is a schematic top view of a portion of a plate with a rotating unit in another embodiment, and FIG. 6 is a schematic side view of rotating unit in another embodiment.

FIG. 1 shows schematically in top view a single plate 1 of the device 2 for storing, managing and/or retrieving data stored on data carriers, in particular on CD's. Not all details has been included in the figures. In the plate 1, being relatively thin and of an oblong shape in top view, there is a recess 3 for a data carrier not shown in the figure. The said recess 3 has an open passage 4. Additionally the plate 1 has two open passages 5, 6 placed along its longitudinal axis 0. The plates 1 of the device 2 are situated one above another, wherein adjoining plates 1 are coupled together by means of shaped grooves 7 and splines 8 which create a circular or partially circular shape in top view. Such coupling allows for independent rotation of the selected plate 1 around a common axis 0′. With identically positioned plates 1, the open passages 5, 6 of all plates create two vertical chambers 9, 10. Inside the first chamber 9 located within a rotating ring created by shaped grooves 7 and splines 8 there is a rotating unit 11. The said unit 11 for rotating plates 1 includes a rod 12 of a square section, located in axis 0′ around which the plates 1 rotate. The rod 12 is connected with a driving unit 13 for rotating the rod 12 by a chosen angle. A sliding body 14 with a plate driver 15 is slidably mounted on the rod 12, wherein the driver 15 for rotating the selected plate 1 rotates together with the rod 12. The end part 16 of the driver 15 reaches a recess 17 of each plate 1. The sliding body 14 is joined by a connector 18 with a belt 19 running along the plates 1 between wheels not shown in the figures. Between two lines of the belt 19 on each plate 1 there is a protrusion 20 whose edges are located close to the lines of the belt 19. The belt 19 fulfils two functions. Firstly, its movement along the plates 1 causes the movement of the sliding body 14 with the driver 15 along the rod 12. Secondly, the belt 19 blocks the protrusions 20 of the plates 1, thus preventing the plates 1 from unwanted rotation. A notch 21 in the belt 19 situated exactly at the level of the driver 15 of the sliding body 14 enables the selected plate 1 to rotate. In a side view the section of the said notch 21 is somewhat larger than the side section of the blocking protrusions 20.

The second chamber 10 is of a somewhat longer diameter than the diameter of CD's stored in recess 3 of plates 1. In the upper part of said chamber 10 above the uppermost plate 1 there is a data reader 22. In the lower part of the chamber 10 there is a lifting unit 23 for transporting data carriers. After the selected plate 1 has been rotated by the pre-selected angle, which process will be described below, the CD is in chamber 10. Then the lifting unit 23 is activated, moving upwards it goes through open passages 4 in the recesses 3 in plates 1, it reaches the selected data carrier and lifts it to the data reader 22. After the process of reading and/or recording and/or processing of data has been finished, which depends on the function of the device 2, the lifting unit 23 moving downwards places the data carrier in its proper recess 3 of the plate 1 and moves back to its initial position. The selected plate 1 is also rotated back to its initial position.

The rotation of plates 1 goes as follows. The device 2 is equipped with a power and control units not shown in the figures. The data carrier is selected when appropriate keys are pressed, for instance on the remote control. Then the belt 19 runs until the notch 21 reaches a plate X containing the selected data carrier. The sliding body 14 with the driver 15 joined with the belt 19 by the connector 18 move along the rod 12 together with the belt 19. After the belt 19 stops in the pre-selected position, the driver 15 is at the same level as plate X, and the end part 16 of the driver 15 is located in the recess 17 of the plate X. Then the driving unit 13 causes the rotation of the rod 12, which also leads to the rotation of the driver 15 by the pre-selected angle. The driver 15 is seated in the sliding body 14 in such a way that during the rotation of the driver 15 the connector 18 and the belt 19 remain motionless. Such a connection can be achieved, for instance, by means of a key joint in which the driver 15 is rotatably set inside the sliding body 14. The rotation of the driver 15 leads to the rotation of the plate X around the axis 0′. The rotation is enabled by the fact that the blocking protrusion 20 goes through the notch 21 of the belt 19. In case of the plates shown schematically in. FIG. 1, the rotation of the plate 1 by 90° allows for the exchange, inserting or removing of the data carrier in or out of the plate, whereas rotation by 180° leads to placing the data carrier in chamber 10 in order to read and/or record and/or process data. Other angled working positions of the plates fall within the scope of the invention.

Additionally, side external elements 24 of the plates 1, at least partly, constitute the casing of the device 2, therefore additional casing is not necessary.

In the embodiment of the invention shown in FIG. 5 the adjoining plates 1 are not connected by means of circular key joints in the form of a groove and a spline, but are mounted on a common hollow core 25, with a top view of a circular sector. In embodiment shown in FIG. 5 the sector of the core is about 200°. Inside the core 25 the rotating unit 11, having identical construction as described above, is situated. When the device 2 is built using the core 25, the chamber 10 for the data reader is located within the angle range less than 180° in relation to the initial position of the data carriers.

FIG. 6 shows schematically the rotating unit 11 in another embodiment. The sliding body 14 of the plates driver 15 is slidably mounted on a rotatable rod 12 of a square section, for instance. Additionally the sliding body 14 is slidably mounted on a stationary rod 26 of a circular section which provides stabilisation and guidance of the sliding body 14. Two ends of a toothed belt are fixed to the sliding body 14, with a break 21′ between them. The protrusion 20 of a selected plate 1 goes through the break 21′, which allows for the rotation of the selected plate 1.

Within the scope of the invention there are manifold possible modifications of the described embodiments. The device can be used for storing data carriers only, but it can also be equipped with an additional chamber with data reader. Moreover, instead of using the lifting unit, the data carrier may not be lifted to data reader and the data reader and/or the recording device may be transported to the data carrier in the plate. Different constructions of the rotating unit are also possible, for instance, according to the state of the art. The rotation of the plates can be blocked by a fixed stop.

1. Device for storing, managing and/or retrieving data stored an data carriers, in particular on CD's, comprising a set of plates with recesses for data carriers, the said plates situated one above another, rotatably in relation to one another, the rotation of a selected plate around a common axis being controlled by a rotating unit equipped with a motor, and a set of strings, characterised by the fact that adjoining plates (1) are connected by shaped key joints (7,8), preferably in the form of a groove and a spline, which alter assembly in top view resemble a circle or a circular sector, and the side external parts (24) of the plates (1) at least partly constitute the casing of the device (2), said plates (1) having open passages (5) which create at least one 15 vertical chamber (9), preferably placed inside a rotatable ring set by key joint (7,8), and a rotating unit (11) of plates (1) is situated inside the chamber (9).

2. Device according to claim 1, wherein the rotating unit (11) is a motor-driven, vertical rod (12) with a non fully circular section, on which a sliding body (14) equipped with a rotatable plate driver (15) for rotating selected plate (X) is mounted, the sliding body (14) of the driver (15) is joined with a movable string (19), preferably in the form of an endless belt running along the plates (1), which string (19) prevents the plates (1) 25 from undesirable rotation and has a recess or a break (21) aligned with the plate driver (15), the said recess or a break (21) being compatible with a blocking protrusion (20) located an each plate (1).

3. Device according to claim 1, wherein additional open passages (6) in the plates (1) create an additional vertical chamber (10) where the data reader (22) and/or recording device and/or lifting unit (23) for transporting data carriers and/or data reader and/or recording device are located.

4. Device according to claim 2, wherein the sliding body (14) of the late driver (15) is additionally slidably mounted on at least one stationary stabilising rod (26).

5. Device for storing, managing and/or retrieving data stored on data carriers, in particular an CD's, comprising a set of plates with recesses for data carriers, the said plates situated one above another, rotatably in relation to one another, the rotation of a selected plate around a common axis being controlled by a rotating unit equipped with a motor and a set of strings, characterised by the fact that adjoining plates (1) are mounted on one common hollow core (25), with a top view being a circular sector preferably in the angle range between 180° and 210°, and the side external parts (24) of the plates (1) at least partly constitute the casing of the device (2), and a rotating unit (11) of the plates (1) is situated inside the core (25).

6. Device according to claim 5, wherein the rotating unit (11) is a motor-driven, vertical rod (12) with a non fully circular section, on which a sliding body (14) equipped with a rotatable plate driver (15) for rotating selected plate (X) is mounted, the sliding body (14) of the driver (15) is joined with a movable string (19), preferably in the form of an endless belt running along the plates (1), which string prevents the plates (1) from undesirable rotation and has a recess or a break (21) aligned with the plate driver (15), the said recess or a break (21) being compatible with a blocking protrusion (20) located an each plate (1).

7. Device according to claim 5, wherein additional open passages (6) in the plates create an additional vertical chamber (10) where the data reader (22) and/or recording device and/or lifting unit (23) for transporting data carriers and/or data reader and/or recording device are located.

8. Device according to claim 6, wherein the sliding body (14) of the plate driver (15) is additionally slidably mounted on at least one stationary stabilising rod (26).
